(19) United States
(12) Patent Application Publication
(10) Pub. No.: US 2010/0303436 A1
(43) Pub. Date: Dec. 2, 2010

(54) VIDEO PROCESSING SYSTEM, VIDEO PROCESSING METHOD, AND VIDEO TRANSFER METHOD

(75) Inventors: Peter Taehwan Chang, Seoul (KR); Dae Hee Kim, Seoul (KR); Kyung Hun Kim, Seoul (KR); Jun Seok Lee, Seoul (KR); Jae Sung Chung, Seoul (KR)

Correspondence Address: OCCHIUTI ROHLICEK & TSAO, LLP, 10 FAWCETT STREET, CAMBRIDGE, MA, 02138, US

(73) Assignee: INNOTIVE INC. KOREA, GANGNAM-GU (KR)

(21) Appl. No.: 12/812,121

(22) PCT Filed: Jan. 12, 2009
(86) PCT No.: PCT/KR2009/000148

§ 371 Date: Aug. 3, 2010

(30) Foreign Application Priority Data
Jan. 12, 2008 (KR) 10-2008-0003703

(51) Int. Cl. H04N 5/77; H04N 5/93

(52) U.S. Cl. 386/223; 386/353; 386/E05.003

(57) ABSTRACT

A video processing system is provided. The video processing system includes: a camera that compresses a captured video and provides the compressed video; a video preparation unit including a playback server that decodes a moving picture compression stream transmitted from the camera and a video processor that processes a video decoded by the playback server; and a display device that displays a video prepared and provided by the video preparation unit. Accordingly, a video captured and compressed by a camera is prepared by decoding, and the video is configured with various output conditions so as to be displayed on a display device. This, in comparison with the convention method in which a required video is decoded and displayed whenever a video display condition changes, the required video can be rapidly displayed within a short period of time, and videos captured by a plurality of cameras can be displayed on one image on a real time basis while maintaining a maximum frame rate of the cameras without restriction of the number of cameras. Therefore, there is an advantage in that a specific video can be zoomed in, zoomed out, or panned on a real time basis at the request of a user, thereby improving a usage rate and an operation response of the video processing system.

### TECHNICAL FIELD

The present invention relates to a video processing system and a video processing method, and more particularly, to a video processing system, a video processing method, and a method of processing video signals between servers, whereby videos captured by a plurality of cameras are decoded in preparation for display.

### BACKGROUND ART

Unattended monitoring systems are used to output video data captured by a closed circuit camera while storing the video data in a recording device. To efficiently control and utilize the unattended monitoring systems, video data provided from a plurality of cameras scattered in many locations needs to be effectively checked and monitored by one display device.

For this, a conventional method is disclosed in the Korean Patent Registration No. 10-0504133 entitled as Method for controlling plural images on a monitor of an unattended monitoring system. In this method, an image area displayed on one display device is split into many areas so that each area displays a video captured by a camera.

According to the conventional method, a plurality of compressed videos are received from a plurality of surveillance cameras or a recording means incorporated into the plurality of surveillance cameras. The plurality of videos received by the recoding means are decompressed and then are respectively output to a plurality of windows which are equally split in one image. The plurality of windows equally split in one image are subjected to merge, separation, and location-change according to input information provided by a user input means by using an image control means stored in a memory included in a playback means for controlling a surveillance monitor.

In the conventional method, a video captured by each camera is compressed in a data format such as JPEG and is then transmitted to the recoding means through a network. The recording means decodes compressed video data and then displays the video data on a display device. To display the video on the display device, the video data captured by each camera has to be decoded and output by a recording device whenever the video data is requested to be displayed on an image area. Therefore, it takes a long operation time to display the video on the display device, which impairs image control on a real time basis. In addition, it is impossible in practice to display the videos captured by the plurality of cameras on one image while maintaining a maximum frame rate and resolution of the cameras on a real time basis.

### DISCLOSURE OF INVENTION

### Technical Problem

The present invention provides a video processing system, a video processing method, and a method of transferring video signals between servers, whereby videos captured by a plurality of cameras are decoded in preparation for display so that the videos can be displayed whenever necessary.

The present invention also provides a video processing system, a video processing method, and a method of transferring video signals between servers, whereby videos captured by a plurality of cameras can be output on one image on a real time basis without restriction of the number of cameras while maintaining a maximum frame rate of the cameras.

The present invention also provides a video processing system, a video processing method, and a method of transferring video signals between servers, whereby a specific video can be zoomed in, zoomed out, or panned on a real time basis at the request of a user.

### Technical Solution

According to an aspect of the present invention, there is provided a video processing system including: a camera that compresses a captured video and provides the compressed video; a video preparation unit including a playback server that decodes a moving picture compression stream transmitted from the camera and a video processor that processes a video decoded by the playback server; and a display device that displays a video prepared and provided by the video preparation unit.

In the aforementioned aspect of the present invention, the playback server may play back a plurality of videos captured by a plurality of the cameras by binding the videos.

In addition, the camera may be provided in a plural number, the plurality of cameras may be connected to at least one hub, and the hub and the playback server may be switched by a switching hub.

In addition, the video processor may include: a video merge server that reconfigures a binding video provided from a plurality of the playback servers; and a display server that configures the binding video reconfigured and transmitted by the video merge server into a full video and that delivers a final output video to the display device by configuring the full video according to a specific output condition.

In addition, the video merge server may be provided in a plural number, and a multiple-merge server may be provided between the display server and the video merge server to process a video of each video merge server.

In addition, the display server may deliver the specific output condition requested by a user to the video merge server, and the video merge server may reconfigure a video conforming to the specific output condition from the binding video played back by the playback server according to the specific output condition and then may deliver the reconfigured video to the display server.

According to another aspect of the present invention, there is provided a video processing method including the steps of: compressing a video captured by a camera and providing the compressed video; decoding the compressed video; preparing a full video by reconfiguring the decoded video according to a specific output condition; and outputting a video conforming to the specific output condition from the full video as a final output video.

In the aforementioned aspect of the present invention, in the decoding step, a plurality of videos captured by a plurality of the cameras may be decoded and thereafter the plurality of videos may be played back by binding the videos.

In addition, in the preparing step, if the video conforming to the specific output condition is included in the full video, the video conforming to the specific output condition may be transmitted by being selected from the full video, and if the video conforming to the specific output condition is not included in the full video, the full video may be reconfigured to include the video conforming to the specific output condition among videos which have been decoded in the decoding step, and the video conforming to the specific output condition may be transmitted by being selected from the reconfigured full video.

In addition, the specific output condition may relate to a video captured by a camera selected by a user from the plurality of cameras, or may relate to a zoom-in, zoom-out, or panning state of a video captured by the selected camera.

According to another aspect of the present invention, there is provided a video processing method, wherein videos captured by a plurality of cameras are compressed and transmitted, the videos compressed and transmitted by the plurality of cameras are decoded and the plurality of videos are continuously played back during a final output is achieved, the plurality of videos are configured into a full video according to a specific output condition with a range blow a maximum resolution captured by the cameras, and a video conforming to the specific output condition is selected from the full video to output the selected video.

In the aforementioned aspect of the present invention, when the specific output condition changes, the video conforming to the changed output condition may be output by being selected from the full video.

In addition, when the specific output condition changes and the video conforming to the changed output condition is not included in the full video, the full video may be reconfigured from the played-back video, and the video conforming to the changed output condition may be output by being selected from the reconfigured video.

According to another aspect of the present invention, there is provided a method of transferring a video signal between a transmitting server and a receiving server for real time video processing, wherein the transmitting server plays back and outputs a plurality of input videos into a decoded video by using a graphic card, wherein the receiving server obtains the decoded video output from the transmitting server by using a capture card, and wherein the transmitting server transmits signals of the decoded video to the receiving server by using a dedicated line.

In the aforementioned aspect of the present invention, the plurality of videos input to the transmitting server may be combination of coded video which are respectively captured by a plurality of cameras, and the receiving server may receive signals of decoded videos from a plurality of the transmitting servers. In addition, the transmitting server may be a playback server, the receiving server may be a video merge server, and the video merge server may transform the decoded videos input from the plurality of transmitting servers into video signals combined in any format according to a request signal input from an external part of the video merge server and may transmit the transformed signals to a display server. In addition, the video merge server may output the video signals combined in any format by being played back into decoded signals, and the display server may obtain the decoded videos output from the video merge server by using the capture card. In addition, the decoded videos received by the receiving server may be videos with a high resolution obtained by the plurality of cameras.

### Advantageous Effects

According to a video processing system, a video processing method, and a video transfer method of the present invention, a video captured and compressed by a camera is prepared by decoding, and the video is configured with various output conditions so as to be displayed on a display device. Thus, in comparison with the convention method in which a required video is decoded and displayed whenever a video display condition changes, the required video can be rapidly displayed within a short period of time, and videos captured by a plurality of cameras can be displayed on one image on a real time basis while maintaining a maximum frame rate of the cameras without restriction of the number of cameras. Therefore, there is an advantage in that a specific video can be zoomed in, zoomed out, or panned on a real time basis at the request of a user, thereby improving a usage rate and an operation response of the video processing system.

### BRIEF DESCRIPTION OF DRAWINGS

FIG. 1 shows a video processing system according to an embodiment of the present invention.

FIG. 2 is a flowchart showing a video processing method according to an embodiment of the present invention.

FIG. 3 shows an example of a binding video configured by a playback server.

FIG. 4A, FIG. 4B, and FIG. 4C are diagrams for explaining embodiments of constituting a full video.

FIG. 5A, FIG. 5B, and FIG. 5C are diagrams for explaining embodiments for a final output video.

FIG. 6 shows a video processing system according to another embodiment of the present invention.

### MODE FOR THE INVENTION

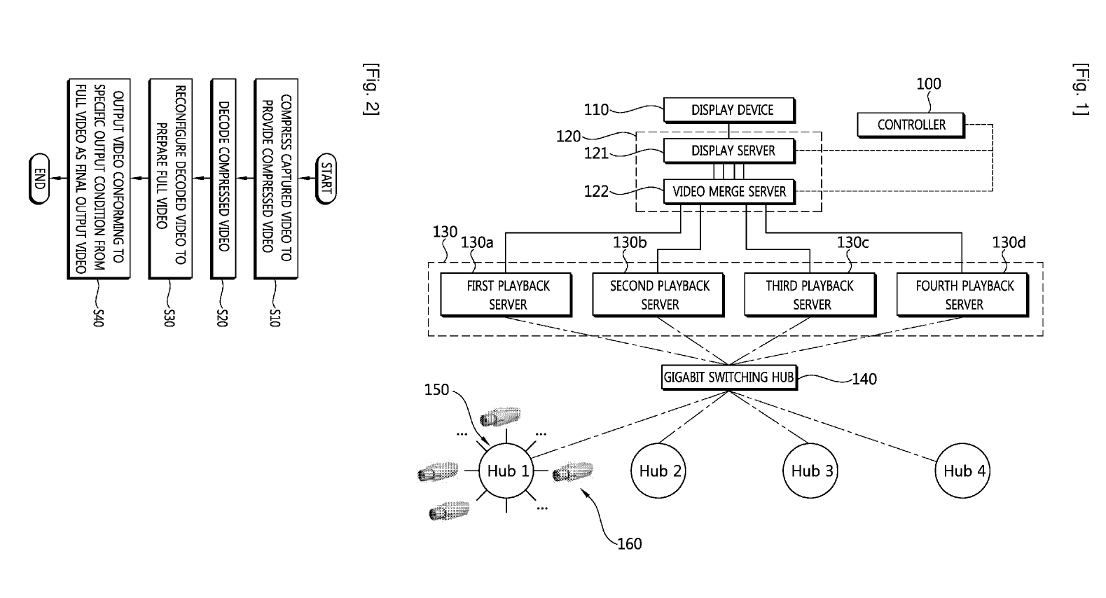

FIG. 1 shows a video processing system according to an embodiment of the present invention. Referring to FIG. 1, the video processing system includes a plurality of cameras 160 connected to a network. The cameras 160 may configure a local area network (LAN), and may be connected to respective hubs 150.

In the present embodiment, the camera 160 includes an encoder that compresses a captured video with a video compression protocol such as MJPEG, MPEG-4, JPEG 2000, etc. Thus, the camera 160 outputs the captured video in a format of a compressed stream. The camera 160 may be an analog camera 160 or a network Internet protocol (IP) camera 160 having a resolution of 640×480.

All of the hubs 150 connected to the cameras 160 control connections for data communication according to an IP address of each camera 160 or a unique address of each camera 160 such as a media access control (MAC) address. Each hub 150 is connected to a gigabit switching hub 140 capable of routing the hubs 150.

A video processor is connected to the gigabit switching hub 140. The video processor includes a plurality of playback servers 130a, 130b, 130c, and 130d and a video preparation unit 120 connected to the plurality of playback servers 130a, 130b, 130c, and 130d through dedicated lines. The gigabit switching hub 140 can route the hubs 150 connected to the camera 160 and each of the playback servers 130a, 130b, 130c, and 130d.

The playback server 130 may be a digital video recorder that includes a recoding medium capable of storing moving picture compression streams provided from the plurality of cameras 160 respectively connected to the hubs 150, a decoder for decoding compressed video data to play back the recorded video, and a graphic card. The four playback servers 130 shown in the present embodiment are for exemplary purposes only, and thus the number of playback servers 130 may be less or greater than four.

All of the playback servers 130a, 130b, 130c, and 130d are connected to the video preparation unit 120. The video preparation unit 120 prepares outputs by sampling the video played back by the playback server 130 without performing an additional decoding process. The video preparation unit 120 may include a video merge server 122 that prepares videos at a fast frame rate and a display server 121 that rapidly edits the videos delivered from the video merge server 122.

The video merge server 122 and the playback server 130 can be connected to two video output ports. The two video output ports may be two digital video interactive (DVI) ports or may be one DVI port and one red, green, blue (RGB) port.

In the present embodiment, the video merge server 122 processes decoded video data received from the four playback servers 130a, 130b, 130c, and 130d. The video merge server 122 can reconfigure the video data at the request of the display server 121 and then can deliver high-quality videos to the display server 121. When the video data is reconfigured, the video merge server 122 processes videos that are received from the playback servers 130a, 130b, 130c, and 130d and that are required for reconfiguration.

The display server 121 connected to the video merge server 122 includes a 4-channel video capture card. The display server 121 selects and edits a video conforming to a specific output condition from a full video (see M1, M2, and M3 of FIG. 4A, FIG. 4B, and FIG. 4C) by using the reconfigured video provided from the video merge server 122. The specific output condition implies that the display server 121 transmits information on the camera 160 for a final output, camera resolution information, etc., to the video merge server 122 in response to user interactions (e.g., a mouse click, a drag, a touch screen operation, etc.). In response to the specific output condition, the video merge server 122 provides a video played back by the playback server 130 to the display server 121 as the video conforming to the specific output condition without an overhead such as an additional decoding process.

Video data configured by the display server 121 according to the specific output condition is transmitted to a display device 110. In this case, the display server 121 divides the video output from the video merge server 122 into a low-resolution image area and a high-resolution image area so that each image is processed by being recognized as a unique object.

The video processing system further includes the display device 110 that is connected to the display server 121 by means of a DVI port or the like and that displays a final output video provided from the display server 121. The video processing system also includes a controller 100 that controls operation of the camera 160, the playback server 130, the video merge server 122, and the display server 121.

Hereinafter, an embodiment of a video processing method will be described.

FIG. 2 is a flowchart showing the video processing method according to the present embodiment. Referring to FIG. 2, when the cameras 160 capture videos at respective positions, the captured videos are compressed by the cameras 160 and are transmitted to the playback server 130 (step S10). The videos to be compressed by the cameras 160 are always captured at a maximum resolution of the cameras 160. That is, in the present embodiment, each camera 160 compresses a video captured at a maximum resolution of 640×480, and then transmits the compressed video to the playback server 130. The playback server 130 decodes the compressed video, binds the videos captured by the plurality of cameras 160 into a binding video P in one image, and then transmits the binding video P to the video preparation unit 120 (step S20).

The video merge server 122 of the video preparation unit 120 reconfigures videos provided from all of the playback servers 130a, 130b, 130c, and 130d and videos conforming to a specific output condition requested by the display server 121, and then transmits the reconfigured videos to the display server 121 (step S30).

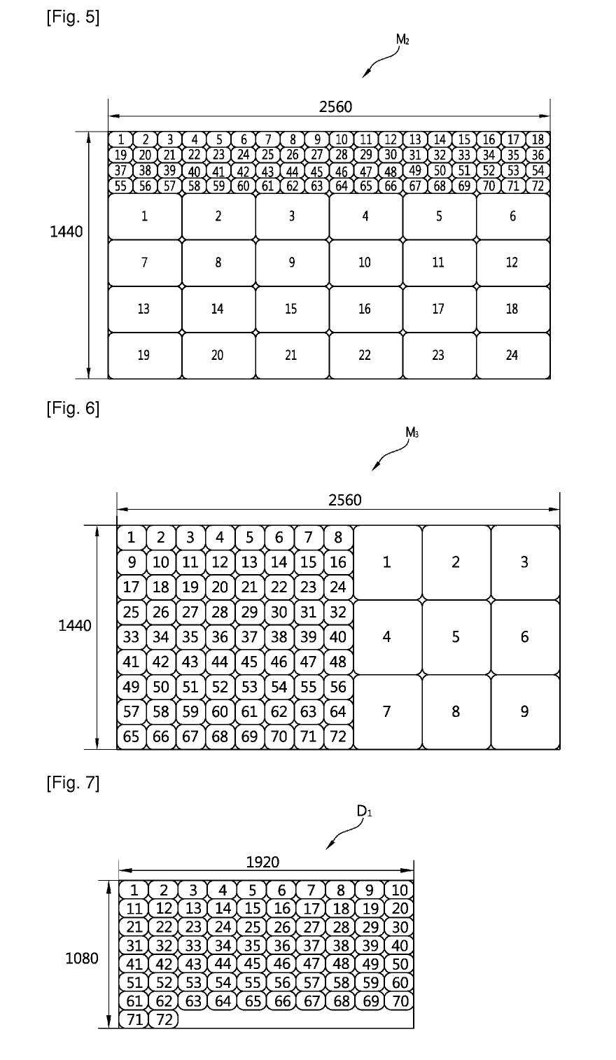

The display server 121 recognizes a default display or various full videos M1, M2, and M3 conforming to a specific output condition requested by a user. Then, the display server 121 determines the default display or the video conforming to the specific output condition among the full videos M1, M2, and M. Then, the display server 121 selects and edits the determined default display or the determined video. When the selected and edited video is delivered to the display device 110, the display device 110 outputs the video as a final output video (see D1, D2, and D3 of FIG. 5A, FIG. 5B, and FIG. 5C) (step S40).

If the display server 121 does not recognize the video conforming to the specific output condition input by the user among the full videos M1, M2, and M3, the display server 121 updates the full videos M1, M2, and M3 to the video data received from the video merge server 122 by using a video including the video conforming to the output condition.

The display server 121 re-edits and reconfigures the video conforming to the output condition from the updated full videos M1, M2, and M3 and delivers the resultant video to the display device 110. The display device 110 outputs the video conforming to the output condition as the final output videos D1, D2, and D3. The specific output condition may be a condition for various image states such as zoom-in, zoom-out, panning, etc., of a specific resolution captured by a specific camera. The resolution may be a maximum resolution captured by the camera 160.

Therefore, the display device 110 outputs videos conforming to various output conditions requested by the user by receiving the videos from the display server 121 on a real time basis, and thus can display a high-resolution video on an image area within a short period of time. Further, when there is a change in a condition of a video to be displayed on the display device 110, the video merge server 122 reconfigures the video played back by the playback server 130 and then delivers the video with a high frame rate and a high resolution to the display server 121 on a real time basis. Accordingly, various videos displayed on the display device 110 can be high-quality videos with a significantly fast response.

Hereinafter, a more detailed embodiment according to a state of an image provided by each constitutional element used in the video processing method will be described with reference to the accompanying drawings.

As described above, when the camera 160 installed in any position receives an operation signal of the controller 100 to start to capture a video of a maximum resolution at that position, the captured video is compressed by an encoder of the camera 160 and is transmitted in a format of a moving picture compressed stream to the playback servers 130a, 130b, 130c, and 130d via the gigabit switching hub 140.

According to the present embodiment, 18 cameras 160 are connected to one hub 150, and one playback server 130 simultaneously plays back 16 images by binding the images. However, the number of cameras 160, the number of playback servers 130, and the number of images decoded and played back by the playback server 130 can change variously. From the next stage of the playback server 130, an encoding or decoding process is not performed on videos when video data is transmitted and output. Instead, a high resolution video is processed on a real time basis for a final output.

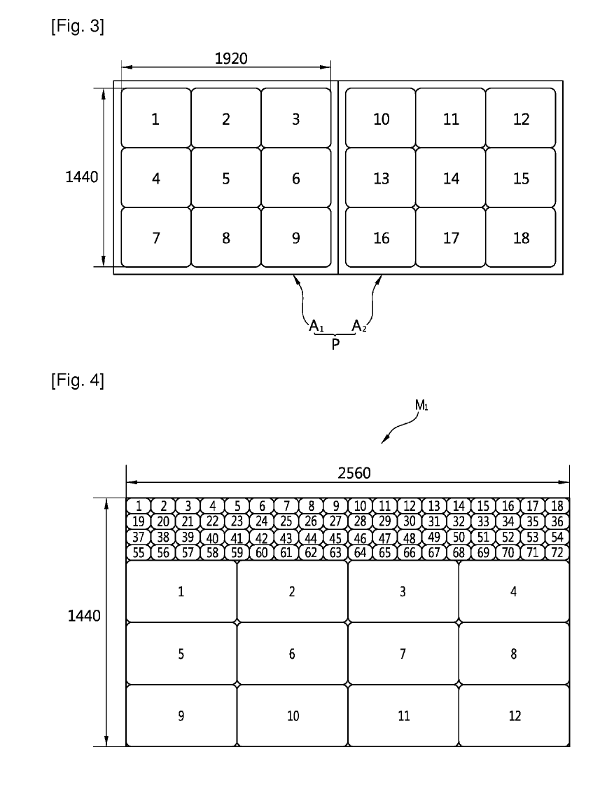

FIG. 3 shows an example of videos played back by the playback servers 130a, 130b, 130c, and 130d in a mosaic view by decoding videos captured by the cameras 160. Hereinafter, the video played back in a mosaic view is referred to as a binding video P.

Referring to FIG. 3, the playback server 130 processes 18 pieces of video data. For this, the playback server 130 configures the binding video P in a mosaic view and plays back the binding video P in two video output areas A1 and A2 which are split in the same size. Thereafter, each playback server 130 transmits the binding video P to the video merge server 122 by using two DVI ports or one DVI port and one RGB port.

One area (i.e., A1 or A2) of the binding video P can be transmitted through one DVI port or one RGB port. If one video included in the binding video P configured by the playback server 130 has a resolution of 640×480, one area (i.e., A1 or A2) can be configured in an image size of 1920×1440 since each area includes 9 videos.

As such, the playback server 130 decodes a video captured by the camera 160 at a resolution used when the video is captured while the camera 160 operates, and then the playback server 130 transmits the video to the video merge server 122. Further, the video merge server 122 rapidly receives an output video transmitted from each of the playback servers 130a, 130b, 130c, and 130d through 8 channels in total.

In addition, the video merge server 122 reconfigures the binding video P transmitted from all of the playback servers 130a, 130b, 130c, and 130d without performing another decoding process and then transmits the reconfigured video to the display server 121. In this case, the video merge server 122 can configure an image content required by the display server 121 in a specific image size. Further, the display server 121 can reconfigure or sample videos according to various output conditions requested by a user.

In the present embodiment, the video merge server 122 reconfigures the binding video P transmitted by the playback server 130 in four image sizes of 1280×720, and transmits the resultant video to the display server 121 by using four DVI ports. Therefore, the full videos M1, M2, and M3 provided by the video merge server 122 to the display server 121 may have a size of 2560×1440. The sizes of the reconfigured video and the full videos M1, M2, and M3 may change variously.

The display server 121 can recognize the full videos M1, M2, and M3 by using various arrangement methods. Images provided by all of the playback servers 130a, 130b, 130c, and 130d can be included in the full videos M1, M2, and M3. The video merge server 122 receives video data updated by the playback servers 130a, 130b, 130c, and 130d on a real time basis and reconfigures an image after continuously updating video data of each image. Then, the video merge server 122 transmits the reconfigured video to the display server 121. Accordingly, by receiving the video reconfigured by the video merge server 122 and transmitted on a real time basis, the display server 121 can recognize and process the full videos M1, M2, and M3 in various arrangement patterns.

Hereinafter, embodiments of a full video will be described.

FIG. 4A, FIG. 4B, and FIG. 4C are diagrams for explaining the embodiments of constituting the full video.

According to a first embodiment shown in FIG. 4A, 72 videos to be decoded by the playback servers 130a, 130b, 130c, and 130d are respectively arranged on an upper one-quarter portion of the full video M1. For example, if the full video M1 with a size of 2560×1440 is displayed by the display server 121, each of 72 base videos 1 to 72 can be displayed with an image size of 120×90. These 72 videos (hereinafter, referred to as base videos) can be used when the videos are provided by the display server 121 as base videos for multi-view. In addition, 12 videos 1 to 12 can be arranged with an image size of a higher resolution than that of a base video in lower three-quarter portions of the full videos M1, M2, and M3 among the total 72 videos.

For example, when images 1 to 12 of the full video M1 are configured with a high resolution, the display server 121 which configures the full video M1 in an image size of 2560×1440 can configure the images 1 to 12 with a maximum resolution, i.e., 640×480.

According to a second embodiment shown in FIG. 4B, 72 videos reconfigured and transmitted by the video merge server 122 are arranged with a low resolution on an upper one-quarter portion of the full video M2. These 72 low-resolution videos can be provided by the display server 121 as base videos for multi-view. In addition, 24 videos can be arranged on lower three-quarter portions of the full video M2 with an image having a higher resolution than that of the base video. In this case, the 24 videos may have a resolution of 320 240.

According to a third embodiment shown in FIG. 4C, 72 videos are respectively arranged with a low resolution on a left one-half portion of the full video M3 by using a reconfigured video received from the video merge server 122. In addition, among the 72 videos, 9 videos can be arranged on a right one-half portion as higher-resolution videos.

That is, as described above, the display server 121 arranges videos reconfigured and transmitted by the video merge server 122 on some portions of the full videos M1, M2, and M3 with a low resolution. In addition thereto, the display server 121 can configure a video partially pre-configured or configured with a specific output condition by using various resolutions and arrangement methods. The respective videos included in the full videos M1, M2, and M3 reconfigured by the video merge server 122 can have a maximum resolution captured by the camera 160. Therefore, when a specific video is finally output, the video merge server 122 provides a high-quality video.

Hereinafter, a detailed embodiment of a method of configuring a final output video will be described.

The display server 121 provides a default display to the display device 110 when an output condition is not additionally input by a user. When the user inputs the output condition such as a specific resolution, zoom-in, zoom-out, panning, etc., for a video captured by a specific camera 160, the display server 121 determines whether the video conforming to the output condition is included in the full videos M1, M2, and M3 configured by the display server 121. If the video conforming to the output condition is included in the full videos M1, M2, and M3, the display server 121 selects and edits the video and transmits the video to the display device 110.

On the contrary, if the video conforming to the output condition is not included in the full videos M1, M2, and M3, the display server 121 reconfigures the full videos M1, M2, and M3 by using reconfigured videos provided from the video merge server 122.

FIG. 5A, FIG. 5B, and FIG. 5C are diagrams for explaining embodiments for a final output video.

FIG. 5A shows a state where the display server 121 completely displays a binding video P encoded by all of the playback servers 130. A default display may be displayed in this case. The default display is a video that can be displayed when a video processing process initially operates. The default display may be an output video that is finally output when the display server 121 selects base videos 1 to 72 from the full video M1, arranges the base videos 1 to 72 with an image size of 1920×1080 displayed by the display device 110, and transmits the videos to the display device 110.

On the contrary, when a user selects some videos from the base videos and inputs an output condition such as zoom-out or zoom-in by using a method for a touch screen operation, a mouse click, a drag, or other user interfaces, the display server 121 selects and edits the selected image from the full video M1 according to the output condition at that moment.

For example, as shown in FIG. 5B, when the user manipulates a user interface to zoom in base videos together with a video 1 with a high resolution captured by a camera among the base videos, a unique identifier for the video 1, a specific resolution, and a column address and a row address of the video 1 are determined and delivered to the display server 121 via the controller 100.

In addition, the display server 121 determines whether the video 1 conforms to the output condition input by the user among the full videos M1, M2, and M3. For example, as shown in FIG. 4A, if the video 1 includes a zoom-in video and has a resolution captured by the camera 160 and conforming to a specific output condition, the display server 121 selects the video 1 from the full videos M1, M2, and M3, and edits and processes video data so that the selected video data is mapped to a column address and a row address of an output video. In this process, the full videos M1, M2, and M3 provided by the video merge server 122 are selected and then immediately output. Thus, a high-quality image can be implemented with a significantly fast frame rate.

In addition to the video conforming to the specific output condition of the video 1, other base videos can also be selected with a default condition and can be provided to the display device 110. Accordingly, in an output video D2 that is output to the display device 110, an enlarged view of the video 1 is displayed together with other base videos in remaining image areas displayable in the display device 110.

According to another embodiment, as shown in FIG. 5C, a user can input a specific output condition through a user interface so that videos 1 to 16 can be enlarged with a high resolution. In this case, enlarged videos of images 13 to 16 are not configured in the full video M1 as shown in FIG. 4A.

On the contrary, the full video M2 of the display server 121 according to the embodiment of FIG. 4B includes enlarged videos of images 1 to 16. Therefore, if the full video M1 of the display server 121 is configured as shown in FIG. 4A, reconfigured videos received from the video merge server 122 are configured into the full video M2 in a state shown in FIG. 4B, and only images 1 to 16 can be selected from the full video M2 so as to be provided to the display device 110. Accordingly, a final output video D3 can be provided as a zoom-in video for the images 1 to 16. In this case, since the video merge server 122 receives a video played back by the playback server 130 on a real time basis, the full videos M1, M2, and M3 are reconfigured within a short period of time. Thus, the display server 121 can select a video and then can transmit a high-quality image to the display device 110 at a significantly fast frame rate.

When a plurality of videos are requested to be zoomed in or zoomed out as described above, according to requested video content, if a requested video corresponds to a video currently configured, the display server 121 immediately selects and edits the video and then transmits the video to the display device 110. Even if the video is not used to configure a current image, the display server 121 rapidly recognizes the full videos M1, M2, and M3 reconfigured and transmitted by the video merge server 122, selects and edits the video required by the full videos M1, M2, and M3 within a short period of time, and transmits the resultant video to the display device 110. Accordingly, various videos requested by the user can be rapidly displayed on the display device 110.

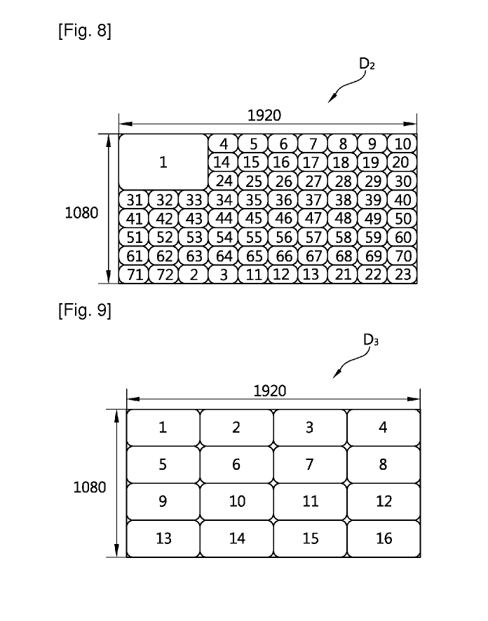

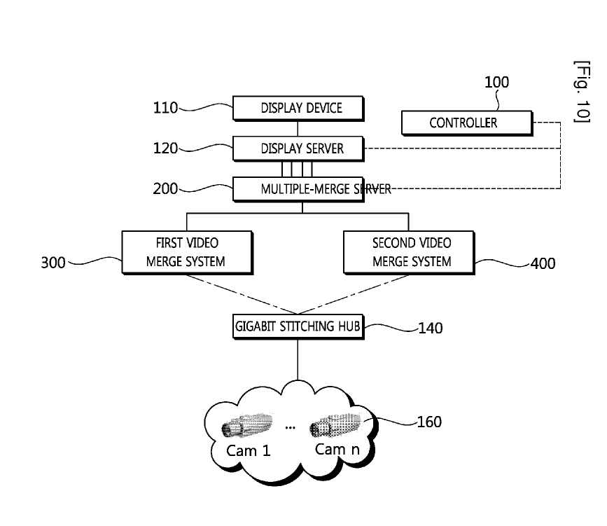

Meanwhile, the video processing system can be extensively used in a broadband environment by using the aforementioned embodiments. FIG. 6 shows the video processing system according to another embodiment of the present invention.

Referring to FIG. 6, a plurality of single-video merge systems 300 and 400, each of which includes a playback server and a video merge server, are provided to process videos captured by a larger number of cameras 160 in a much wider area. A video can be displayed by using a display server 120 and a display device 110 after the single video merge systems 300 and 400 are connected to one multiple-merge server 200. In such an embodiment, a larger number of images can be rapidly processed in a much wirer area.

In the aforementioned video processing system and the video processing method according to the present embodiment, when video information is transmitted between the playback server and the video merge server and between the display servers, video processing is not achieved by transmitting a compressed video format through a data network. Instead, a required video is captured from videos transmitted from the playback server that plays back videos by binding a plurality of videos. Therefore, in the present embodiment, a method of transferring video information between servers can skip an overhead procedure in which compression/decompression is performed to transmit the video information. As a result, video processing can be performed on a real time basis. In addition, instead of using a data transfer network (e.g., Ethernet) shared by several servers, data is transferred through a dedicated line between servers, and thus a much large amount of video information can be transmitted at a high speed. Accordingly, a high quality state can be maintained, and a video to be zoomed in, zoomed out, or panned can be displayed on a real time basis.

1. A video processing system comprising:
a camera that compresses a captured video and provides the compressed video;
a video preparation unit comprising a playback server that decodes a moving picture compression stream transmitted from the camera and a video processor that processes a video decoded by the playback server; and
a display device that displays a video prepared and provided by the video preparation unit.

2. The video processing system of claim 1, wherein the playback server plays back a plurality of videos captured by a plurality of the cameras by binding the videos.

3. The video processing system of claim 1, wherein the camera is provided in a plural number, the plurality of cameras are connected to at least one hub, and the hub and the playback server are switched by a switching hub.

4. The video processing system of claim 1, wherein the video processor comprises:
a video merge server that reconfigures a binding video provided from a plurality of the playback servers; and
a display server that configures the binding video reconfigured and transmitted by the video merge server into a full video and that delivers a final output video to the display device by configuring the full video according to a specific output condition.

5. The video processing system of claim 4, wherein the video merge server is provided in a plural number, and a multiple-merge server is provided between the display server and the video merge server to process a video of each video merge server.

6. The video processing system of claim 4, wherein the display server delivers the specific output condition requested by a user to the video merge server, and the video merge server reconfigures a video conforming to the specific output condition from the binding video played back by the playback server according to the specific output condition and then delivers the reconfigured video to the display server.

7. A video processing method comprising the steps of:
compressing a video captured by a camera and providing the compressed video;
decoding the compressed video;
preparing a full video by reconfiguring the decoded video according to a specific output condition; and
outputting a video conforming to the specific output condition from the full video as a final output video.

8. The video processing method of claim 7, wherein, in the decoding step, a plurality of videos captured by a plurality of the cameras are decoded and thereafter the plurality of videos are played back by binding the videos.

9. The video processing method of claim 7, wherein, in the preparing step, if the video conforming to the specific output condition is included in the full video, the video conforming to the specific output condition is transmitted by being selected from the full video, and if the video conforming to the specific output condition is not included in the full video, the full video is reconfigured to include the video conforming to the specific output condition among videos which have been decoded in the decoding step, and the video conforming to the specific output condition is transmitted by being selected from the reconfigured full video.

10. The video processing method of claim 9, wherein the specific output condition relates to a video captured by a camera selected by a user from the plurality of cameras, or relates to a zoom-in, zoom-out, or panning state of a video captured by the selected camera.

11. A video processing method, wherein videos captured by a plurality of cameras are compressed and transmitted, the videos compressed and transmitted by the plurality of cameras are decoded and the plurality of videos are continuously played back during a final output is achieved, the plurality of videos are configured into a full video according to a specific output condition with a range blow a maximum resolution captured by the cameras, and a video conforming to the specific output condition is selected from the full video to output the selected video.

12. The video processing method of claim 11, wherein, when the specific output condition changes, the video conforming to the changed output condition is output by being selected from the full video.

13. The video processing method of claim 11, wherein, when the specific output condition changes and the video conforming to the changed output condition is not included in the full video, the full video is reconfigured from the played-back video, and the video conforming to the changed output condition is output by being selected from the reconfigured video.

14. A method of transferring a video signal between a transmitting server and a receiving server for real time video processing,
wherein the transmitting server plays back and outputs a plurality of input videos into a decoded video by using a graphic card,
wherein the receiving server obtains the decoded video output from the transmitting server by using a capture card, and
wherein the transmitting server transmits signals of the decoded video to the receiving server by using a dedicated line.

15. The method of claim 14,
wherein the plurality of videos input to the transmitting server are combination of coded video which are respectively captured by a plurality of cameras, and
wherein the receiving server receives signals of decoded videos from a plurality of the transmitting servers.

16. The method of claim 15,
wherein the transmitting server is a playback server, and the receiving server is a video merge server, and
wherein the video merge server transforms the decoded videos input from the plurality of transmitting servers into video signals combined in any format according to a request signal input from an external part of the video merge server and transmits the transformed signals to a display server.

17. The method of claim 16, wherein the video merge server outputs the video signals combined in any format by being played back into decoded signals, and the display server obtains the decoded videos output from the video merge server by using the capture card.

18. The method of claim 15, wherein the decoded videos received by the receiving server are videos with a high resolution obtained by the plurality of cameras.
